(19) United States
(12) Patent Application Publication
(10) Pub. No.: US 2004/0004130 A1
(43) Pub. Date: Jan. 8, 2004

(54) Identification module for mobile platform

(76) Inventor: Phillip R. Rotta, Kirkland, WA (US)

Correspondence Address: HARNESS, DICKEY & PIERCE, P.L.C., P.O. BOX 828, BLOOMFIELD HILLS, MI, 48303, US

(21) Appl. No.: 10/190,934

(22) Filed: Jul. 8, 2002

(51) Int. Cl. G06K 19/06

(52) U.S. Cl. 235/492

(57) ABSTRACT

An identification (ID) module for use with a mobile platform, such as an aircraft, which forms a part of the aircraft installation, and which can therefore not be readily removed from the aircraft once installed. In one preferred form the ID module is mechanically and electrically coupled to an ARINC 600 connector. The ARINC 600 connector is then used to interface the ID module with an electronics unit carried on the aircraft. While the electronics unit may be removed as needed for service and/or maintenance, the ID module, advantageously, forms a permanent part of the aircraft installation. This eliminates the possibility of the important identification information associated with a given aircraft being inadvertently lost or transferred to a different aircraft if the ID module was removable. The ID module forms a simple yet effective means for communicating important ID information associated with the aircraft to other aircraft or to other spaced based or ground based communication systems having a need to identify the aircraft with a unique identification code.

### FIELD OF THE INVENTION

The present invention relates to systems for identifying mobile platforms having an identification number or code, and more specifically to an electronic module which is adapted to be electrically and mechanically coupled to an existing mobile platform or connector used on the mobile platform so that the identification module cannot be readily removed from the mobile platform.

### BACKGROUND OF THE INVENTION

In applications where one of a plurality of mobile platforms, such as, for example, one of a plurality of aircraft, need to be identified, it is common to provide some form of identification code to the aircraft. This allows the aircraft to identify itself to other aircraft or with a base station with which it is in communication with. With the “Connexion by Boeing^{SM}” system, such identification is required to provide a specific network node address which is explicitly associated with a single aircraft. In this manner, a network operation center can identify and communicate with a given aircraft from many aircraft operating within a given coverage region and supply the requested information content to a given aircraft. Other important, aircraft specific information such as calibration and configuration related information also needs to be automatically associated with a specific aircraft.

An identification code as described above, could be programmed into one or more of the electronic units that are typically carried on a commercial aircraft. However, information contained in an electronic unit is not tied directly to the aircraft installation (i.e., the components that are not readily removable from the aircraft) and thus could be separated from the aircraft during normal maintenance actions as electronic units are removed and replaced for service by aircraft mechanics. Thus, associating the identification code or information of a given aircraft with an electronic unit of the aircraft that is capable of being readily removed for service gives rise to a risk that the identification code for a given aircraft could be lost or confused with a different aircraft when the electronic units are replaced.

Previously, an aircraft ID has been associated with a specific aircraft installation by uniquely wiring a set of connector pins within each aircraft installation to be read by an electronic unit of the aircraft via discrete interface pins. Such an approach can require 25 or more connector pins. This, in turn, contributes to the need for larger and more expensive, and heavier, connectors. It also increases installation complexity and span time, and gives rise to an increased chance for wiring errors during installation due to the larger number of wires involved and the uniqueness between each installation, in addition to providing an increased susceptibility to electromagnetic interference (EMI). The increased number of connector pins also can contribute to a decrease in the reliability of the connector.

Therefore, it would be highly desirable to be able to retain an identification code for a mobile platform, for example an aircraft, which cannot be lost or corrupted because of the removal of one or more electronic units or other electronic components of the aircraft during normal surface and/or maintenance operations. It would also be desirable to accomplish this without the need for attaching a large plurality of wires to existing connectors used on a mobile platform. By providing some means for tying the identification code to the mobile platform installation, the risk of losing an identification code for a given mobile platform is significantly reduced.

### SUMMARY OF THE INVENTION

The present invention is directed to an identification (ID) module that is physically and electronically coupled to a portion of a component of a mobile platform which forms a portion of the mobile platform installation, and therefore cannot be readily removed from the mobile platform. In one preferred form, the present invention is directed to an ID module that is electrically and physically coupled to an electrical connector, and where the connector forms a part of the mobile platform installation. In an even more preferred form, the present invention forms an ID module which is mechanically and electrically coupled to a fixed ARINC 600 electrical connector adapted to be coupled to a removable electronic unit used on a commercial aircraft.

In one preferred form the ID module of the present invention comprises a housing which houses a memory for storing an identification code uniquely associated with the mobile platform. The ID module receives power from the electronics unit to which it is coupled via the ARINC 600 connector, as well as a clock signal. A data input/output (IO) port is also in communication with the electronics unit for allowing the electronics unit to query the ID module and obtain the identification information stored therein.

A principal advantage of the ID module of the present invention is that since it is mechanically coupled to the ARINC 600 connector, it cannot be readily separated from the mobile platform installation. Thus, there is virtually no risk that the ID module will be inadvertently removed from the mobile platform and reinstalled in a different mobile platform. The identification code can be programmed into the ID module during installation of the module via the electronics unit after the ID module is installed on the ARINC 600 connector.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a mobile platform identification module in accordance with a preferred embodiment of the present invention;

FIG. 2 is a plan view of the identification module of FIG. 1 secured to a conventional ARINC 600 connector, which forms a part of an aircraft installation;

FIG. 3 is a simplified block diagram drawing of the identification module of the present invention coupled to the ARINC 600 connector shown in FIG. 2, with the connector in turn coupled to an electronics unit of the connector;

FIG. 4 is a simplified block diagram of the internal components of the identification module of the present invention; and

FIG. 5 is a simplified block diagram of an alternative preferred embodiment of the ID module for use with an RS-485 interface.

### DETAILED DESCRIPTION OF THE PREFERRED EMBODIMENTS

The following description of the preferred embodiment(s) is merely exemplary in nature and is in no way intended to limit the invention, its application, or uses.

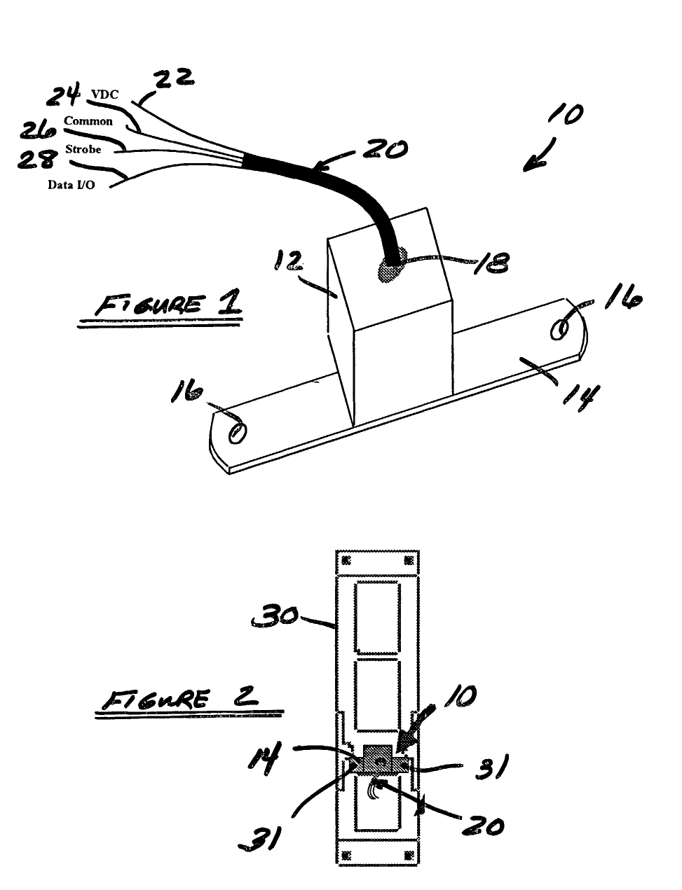

Referring to FIG. 1, there is shown an identification (ID) module 10 in accordance with a preferred embodiment of the present invention. The ID module 10 is ideally suited to be used on mobile platform where it is highly desirable to make the ID module 10 a part of the mobile platform installation such that it cannot be readily removed from the mobile platform. The ID module 10 is especially well suited for use on commercial aircraft, and the following description will make reference to implementation of the ID module 10 in connection with such commercial aircraft. However, it will be appreciated that the ID module 10 could be used with a wide variety of mobile platforms such as ships, busses, trains, etc. where it may be desirable to provide a unique identification code to a particular mobile platform for identifying that specific mobile platform.

The ID module 10 incorporates a housing 12 having a pair of flanges 14 with holes 16. An opening 18 allows an electrical cable 20 to protrude therefrom. The cable 20 carries preferably four conductors, one for DC power 22, a ground 24, a “strobe” 26 (i.e., “clock”), and a data input/output “I/O” 28 conductor. The housing 12 may be made of any material, such as aluminum or molded plastic, that is sufficiently strong and preferably lightweight to enclose the electronic components of the ID module 10.

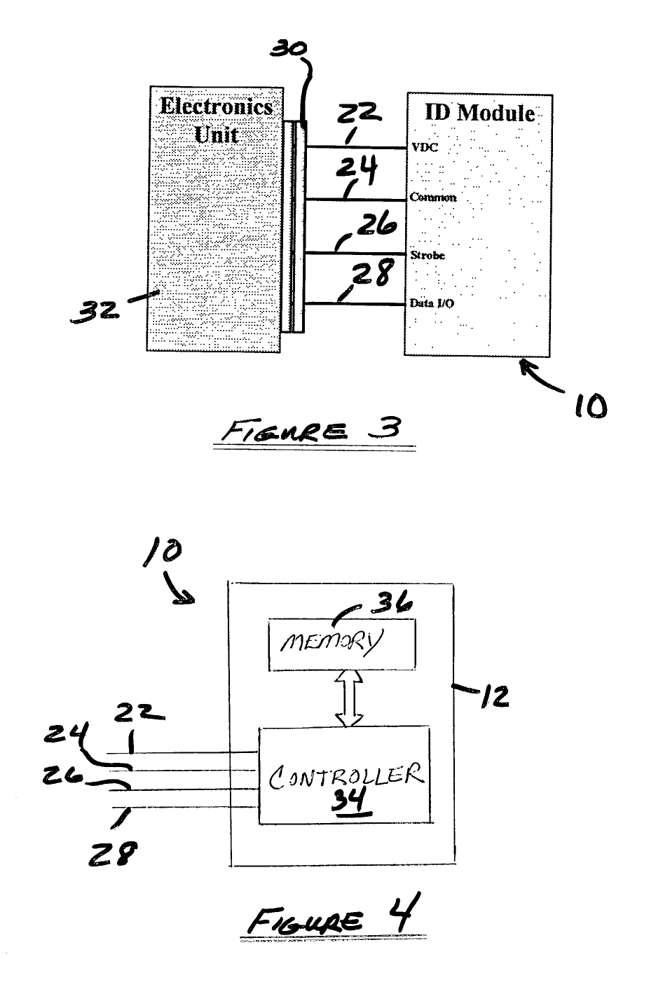

Referring to FIG. 2, the ID module 10 is shown coupled to a conventional ARINC 600 connector 30. The conductors 22, 24, 26, and 28 are coupled to appropriate pins of the ARINC 600 connector 30 such that DC power can be supplied to the ID module 10 via conductor 22. The ID module 10 is also coupled to a ground pin (not specifically shown) of the connector 30 via conductor 24. A pin carrying a strobe signal from the connector 30 supplies a clock signal to the strobe conductor 26 of the ID module 10, and a pin associated with a data line allows data to be communicated to and from the data I/O conductor 28 of the ID module 10.

The ID module 10 is fixedly coupled via suitable fasteners 31 such as threaded screws, rivets, etc. to the ARINC 600 connector 30. Thus, the ID module 10 cannot be readily removed from the ARINC 600 connector 30 and therefore becomes a part of the aircraft installation. Advantageously, the ID module 10 is compact, lightweight, and does not add appreciably to the complexity, size or weight of the ARINC 600 connector 30, nor does it adversely affect the handling and manipulation of the connector 30. In one preferred form, the ID module is approximately 1.4 inch×0.5 inch×0.5 inch (35.56 mm×12.7 mm×12.7 mm).

Referring to FIG. 3, the ARINC 600 connector 30 is intended to couple to an electronics unit 32 of the aircraft or other form of mobile platform. It will be appreciated that the electronics unit 32 comprises a component which may need to be removed from time to time for service and/or repair or replaced by a different but identical electronics unit. If the ID module 10 were associated with the electronics unit 32, then the risk would exist that if the electronics unit 32 is removed from a given aircraft but then subsequently installed in a different aircraft, the unique identification information stored in the ID module 10 could be applied to the wrong aircraft. By fixedly coupling the ID module 10 to the connector 30, this risk is eliminated, since the ARINC 600 connector 30 forms a part of the aircraft installation and is therefore not able to be readily removed from the aircraft.

In operation, the electronics unit 32 operates as the “master” and the ID module 10 operates as the “slave”. Communication between the electronics unit 32 and the ID module 10 can alternately be accomplished via a standard RS-485 low speed interface, by a RS-422 interface, by a RS-232 interface, by an optical fiber, by infrared coupling, or by some other form of wireless coupling. Upon input from an installation person, the electronics unit 32 commands the ID module to store a unique identification code for a specific aircraft. While in service, the electronics unit 32 can at any time request the aircraft ID information from the ID module 10. When an electronics unit 32 is removed and replaced, the new electronics unit automatically requests the aircraft identification code from the ID module 10, thus providing any external system attempting to communicate with the aircraft with the necessary information to identify the aircraft from among a plurality of aircraft.

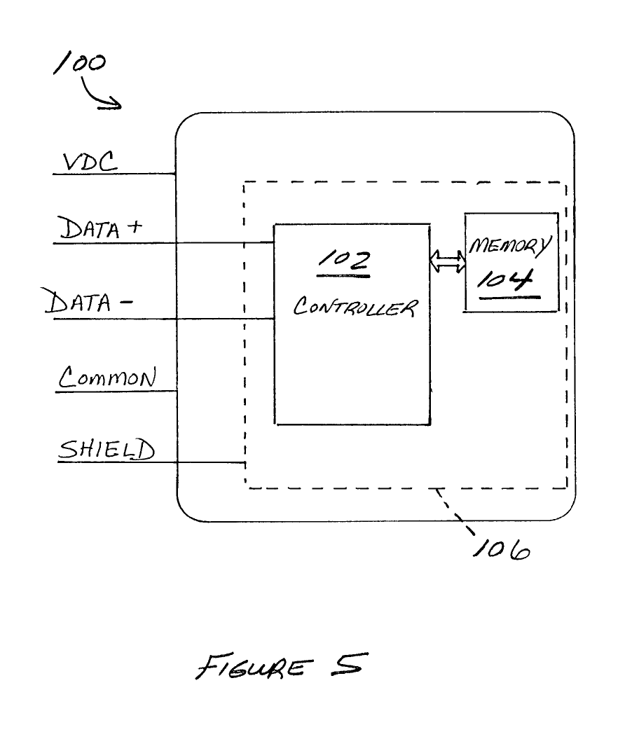

Referring to FIG. 4, the ID module 10 includes a controller 34 that may comprise a small processor, a micro controller, a Field Programmable Gate Array (FPGA), or an Application Specific Integrated Circuit (ASIC). The controller 34 is in bidirectional communication with a memory 36, which is comprised of Random Access Memory (RAM), Read Only Memory (ROM), and programmable non-volatile memory such as Electrically Erasable Programmable Read Only Memory (EEPROM). It will be appreciated that memory 36 functionality could be included on a single integrated circuit along with the controller functionally if desired.

Referring to FIG. 5, an ID module 100 in accordance with an alternative preferred embodiment of the present invention is shown. The ID module 100 is similar to ID module 10 in that it includes a controller 102, which is in bidirectional communication with memory 104. Memory 104 comprises ROM, RAM, and EEPROM. The controller 102, however, is capable of communicating via a more robust RS-485 interface. This is accomplished by the use of “Data+” and “Data−” inputs to the controller 102, which form an electrically balanced data bus. In addition, a shield, represented in highly simplified terms by dashed line 106, provides additional protection against electromagnetic interference (EMI) and against EMI emissions. The RS-485 data interface provides a minimum electrical conductor solution that is electrically robust, balanced, and shielded. The RS-485 interface also has the advantage of being a standard electrical interface.

The ID module of the present invention represents a lightweight, low power, reliable, easy to install component. The ID module further eliminates possible wiring errors because of the limited number of electronical conductors (i.e., four) that must be connected to the ARINC 600 connector. It also provides a cost effective solution, from a manufacturing and inventory perspective, because a number of identical ID modules can be used for identifying a corresponding number of aircraft, thus making the ID modules interchangeable. The limited number of conductors associated with the ID module further significantly reduces risk of EMI problems. The ID module requires very little power and provides a very reliable means for associating important, aircraft-specific information with a specific aircraft.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

What is claimed is:

1. A data module for use with an existing electrical component of a mobile platform for providing stored data concerning the mobile platform, and wherein the existing electrical component is not intended to be readily removable from the mobile platform and communicates with a removable electronics subsystem of the mobile platform, the data module comprising:
a housing adapted to be fixedly coupled to, and carried by, said existing electrical component;
a data port for communicating said stored data associated with said mobile platform to said electronics subsystem; and
a power port for receiving electrical power from said existing electrical component.

2. The data module of claim 1, further comprising a strobe input for receiving a clock signal from said electronics subsystem.

3. The data module of claim 1, further comprising a ground input for coupling with an electrical ground associated with said electronics subsystem.

4. The data module of claim 1, wherein said data port comprises a bidirectional data port for receiving electrical signals from said existing electrical component and for transmitting said stored data to said existing electrical component.

5. The data module of claim 1, wherein said data module is operable to store identification information pertaining to an identification code associated with said mobile platform.

6. The data module of claim 1, wherein said data port comprises Data+and Data−data lines for use with an RS-485 interface.

7. The data module of claim 1, further comprising a shield for shielding said data module from electromagnetic interference.

8. A data module for use with an existing electrical connector of a mobile platform for providing stored data concerning the mobile platform, and wherein the existing electrical connector is not intended to be readily removable from the mobile platform and communicates with a removable electronics subsystem of the mobile platform, the data module comprising:
a housing adapted to be fixedly coupled to, and carried by, said existing electrical component such that said data module can be coupled to communicate with said electronics subsystem via said existing electrical connector;
a memory for storing said stored data;
a data port for communicating said stored data associated with said mobile platform to said electronics subsystem;
a power port for receiving electrical power from said existing electrical component; and
a ground port for providing a ground path from said data module to a ground of said existing electronics subsystem.

9. The data module of claim 8, wherein said data port comprises a bidirectional data port for receiving signals from said electronics subsystem and for transmitting said stored data to said electronics subsystem.

10. The data module of claim 8, further comprising a strobe input for receiving a clock signal.

11. The data module of claim 8, wherein said existing electrical connector comprises an ARINC 600 electrical connector.

12. The data module of claim 8, wherein said stored data stored by said data module comprises identification information concerning said mobile platform.

13. The data module of claim 8, wherein said data port is adapted to communicate in accordance with an RS-485 interface standard.

14. The data module of claim 8, further comprising a shield for shielding said data module from electromagnetic interference.

15. A data module for use with an existing ARINC 600 electrical connector of an aircraft for providing stored data concerning the aircraft, and wherein the existing ARINC 600 electrical connector is not intended to be readily removable from the aircraft and communicates with a removable electronics subsystem of the mobile platform, the data module comprising:
a housing adapted to be fixedly coupled to, and carried by, said existing ARINC 600 electrical connector such that data module can be coupled to communicate with said electronics subsystem via said existing ARINC 600 electrical connector;
a memory for storing said stored identification data concerning this aircraft;
a data port for communicating said stored identification data to said electronics subsystem via said ARINC 600 electrical connector;
a power port for receiving electrical power from said existing electrical component via said ARINC 600 electrical connector;
a strobe port for receiving a clock signal form said electronics subsystem via said ARINC 600 electrical connector; and
a ground port for providing a ground path from said data module to a ground of said existing electronics subsystem.

16. The data module of claim 15, wherein said data port is adapted to communicate in accordance with an RS-485 interface protocol.

17. A method for providing information concerning a particular mobile platform to an electronics subsystem located on-board the mobile platform, and wherein the electronics subsystem is adapted to be readily removable from the mobile platform, the method comprising:
using a data module to store information concerning said mobile platform;
physically and electrically coupling said data module to a portion of an existing electrical connector associated with a wiring harness of said mobile platform such that said data module cannot be readily removed from said existing electrical connector, and wherein said existing electrical connector is further adapted to be releasably coupled to a mating electrical connector of said electronics subsystem to electrically communicate with said electronics subsystem; and
using said electronics subsystem to access said data module to obtain said stored information concerning said mobile platform.

18. The method of claim 17, wherein the step of physically and electrically connecting said data module comprises physically and electrically connecting said data module to an ARINC 600 electrical connector.

19. The method of claim 17, wherein the step of using a data module comprises using a data module to store identification information concerning said mobile platform.

20. The method of claim 17, further comprising:
using said data module to receive a clock signal from said electronics subsystem.

21. The method of claim 17, further comprising:
using said data module to receive data from said electronics subsystem; and
storing said data in said data module for later retrieval by said electronics subsystem.

22. The method of claim 17, wherein said step of using said electronics subsystem to access said data module comprises communicating with said data module via an RS-485 interface protocol.
